(19) United States
(12) Patent Application Publication
(10) Pub. No.: US 2004/0044593 A1
(43) Pub. Date: Mar. 4, 2004

(54) Internet based collectables management and sale system

(76) Inventor: Clifford May, Sterling Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/229,408

(22) Filed: Aug. 27, 2002

(51) Int. Cl. G06F 17/60

(52) U.S. Cl. 705/28

(57) ABSTRACT

An Internet based collectables management system includes a plurality of users each of which operates a store. Each store facilitates inventory tracking, trading, transactions, online pricing, and valuation of collectables. An inventory list provides user selectable transaction option such as: For Sale; For Trade; for auction; and for display for each collectable. Interaction specific to collectables is facilitated thereby. The collectables are not necessarily offered For Sale or trade. The collectables may simply be displayed in a users store to stimulate browsing and interaction with other collectors. The system contains a complete reference digest of all collectables. The reference digest allows users to search and browse through a large database of collectable to find prices and information of known boxes, sets pack or other related collectable. As transactions take place within the system the reference digest is updated. Valuation within the reference digest is also updated by users input.

### BACKGROUND OF THE INVENTION

The present invention relates to an internet based trading and sales system, and more particularly to an internet based collectables management system which provides customizable online store capabilities for a multiple of individual users to facilitate inventory tracking, trading, transactions, online pricing, and “stock market” type trading of collectables.

Many people enjoy collecting various things for a hobby or for other reasons. Trading card collecting has been especially popular and as sold in a package with another product such as bubble gum. The cards each have a figure pictured thereon with his statistics and a brief write-up on him. The collector may seek to collect a desired set of cards.

To obtain the desired cards the collector can purchase them from the original source if still available and/or can trade less desirable cards with other collectors for desired cards. The negotiating and interactions with other collectors is a big attraction to the collection activity. While typically the trading takes place informally with just a few people gathered together, large trading conventions have been held in an attempt to satisfy the growing trading interest, needs and demands. In other words, people are continually looking for different items to collect, and different more entertaining ways of trading and collecting.

Internet based auction sites are well known. A user signs up to the particular site such that the user may participate in the sale and purchase of various displayed items. When a sale is made or an auction is completed the auction site receives a small percentage of the sale price. Such auction sites have been quite successful.

Conventional auction systems require that each displayed item be offered For Sale or be up for auction. Moreover, each auction site user and item are displayed individually under the overall auction site format. That is, each item is displayed in a manner similar to every other item. Disadvantageously, conventional auction systems may not be appropriate for collectables as auction based systems may not capture the negotiating and interactions with other collectors of similar interests.

Accordingly, it is desirable to provide an Internet based collectables management system which facilitates transactions and interaction specific to collectables.

### SUMMARY OF THE INVENTION

The Internet based collectables management system according to the present invention includes a plurality of users each of which operates one or more stores. Each store facilitates inventory tracking, trading, transactions, online pricing, and valuation of collectables. Unlike conventional auction sites a user of the present invention creates a store which contains a multiple of collectables. The store typically contains collectables of a related type. Interaction specific to collectables is facilitated thereby. The collectables are not necessarily offered For Sale or trade. The collectables may simply be displayed in a store to stimulate browsing and interaction with other collectors.

Once a user subscribes to the system and creates a store, the user adds an inventory. Each collectable is added to an inventory list. The system contains a complete reference digest of all collectables. The reference digest allows users to search and browse through a large database of collectable to find prices and information of known boxes, sets packs or other related collectables.

As transactions take place within the system the reference digest is updated each execution. That is, when a particular collectible is sold, the price of the sale is tracked and stored within the reference digest. A value trade history or valuation is therefore generated which is updated as more sales are completed. Valuation within the reference digest is also updated by users input such as by original purchase price.

The inventory list provides user selectable transaction options for each collectable. The user is provided with options such as: mark the collectable For Sale for a particular price; mark the collectable For Trade; mark the collectable for auction on a third party auction site; or mark the collectable for display only. The inventory list also includes attachment of one or more images of the collectable to further facilitate trading. The images are displayed in the each users store and may be stored on a third party site such as Filingtank.com.

Various purchase and trading options for a user to obtain collectables are also provided. Again, unlike conventional auction sites which do not have such request options, a user of the present invention is provided with a collector specific interaction experience.

A user searches from a buyers market which displays all collectables that the user has marked in their Want List and that are available For Sale or trade in other stores. A Seller's Market displays all of the items that the user is selling in their store with what other user's have in their Want List. The user can then communicate to discuss a sale or trade.

The present invention therefore provides an Internet based collectables management system which facilitates transactions and interaction specific to collectables.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general schematic view of the system according to the present invention;

FIG. 2 is a screen shot of the present invention;

FIG. 3 is another screen shot of the present invention;

FIG. 4 is another screen shot of the present invention;

FIG. 5 is another screen shot of the present invention;

FIG. 6 is another screen shot of the present invention;

FIG. 7 is another screen shot of the present invention;

FIG. 8 is another screen shot of the present invention;

FIG. 9 is another screen shot of the present invention;

FIG. 10 is another screen shot of the present invention;

FIG. 11 is another screen shot of the present invention; and

FIG. 12 is another screen shot of the present invention.

### DETAILED DESCRIPTION OF THE PREFERRED EMBODIMENT

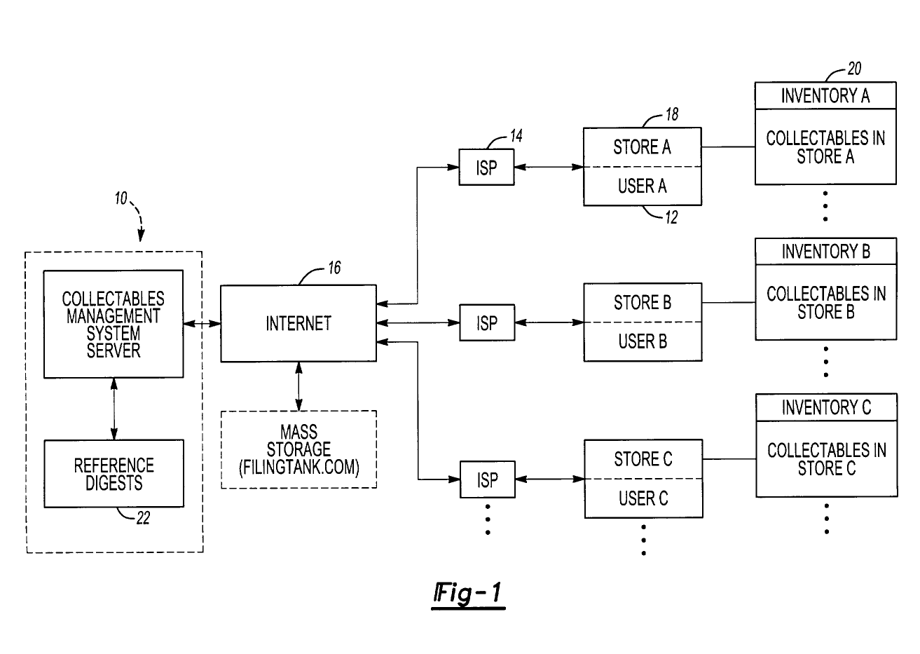

FIG. 1 illustrates a general schematic view of an Internet based collectables management system 10. The collectables management system 10 is preferably a server based system which allows full browse/buy/sell/trade access to an individual user for a particular subscription fee. A user 12 utilizes a computer for connection to the system 10 through the Internet or the like. The user utilizes standard personal computers, emerging so-called network computers, computer/TV devices designed specifically to operate over the Internet, or other data entry systems which permit two-way communication over the Internet (generally via email or a web browser.) Each user 12 accesses the Internet through a computer server 14 of an Internet service provider (ISP). The ISP server 14 is connected to the Internet, a network of computers, represented by an Internet computer 16 upon which the system 10 runs.

Each user creates a store 18 which operates under the umbrella of the system 10. That is, the system includes a plurality of users each of which operates one or more stores. Each store 18 facilitates inventory tracking, trading, transactions, online pricing, and stock market valuation of collectables 20. It should be understood that the term “collectible” as used herein should be construed broadly and should not be limited to trading cards even though trading cards are the primary example used in the disclosed embodiment. Other collectables such as book, firearms, toys, stuffed animals and the like will also benefit from the present invention.

Unlike conventional auction sites a user 12 of the present invention creates a store which contains a multiple of the user collectables. Although each store 18 is schematically illustrated adjacent a user 12, it should be understood that the stores and other information are preferably stores on system 10. Preferably, the store contains collectables 20 of a related type. Interaction specific to collectables is facilitated thereby. The collectables are not necessarily offered For Sale or trade. The collectables may simply be displayed in a users store to stimulate browsing and interaction with other collectors.

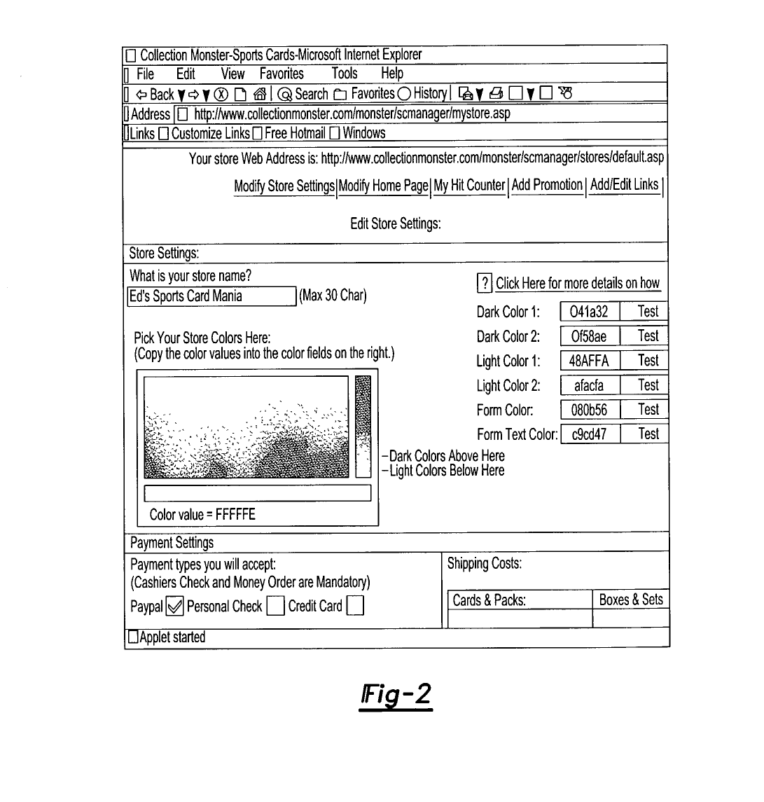

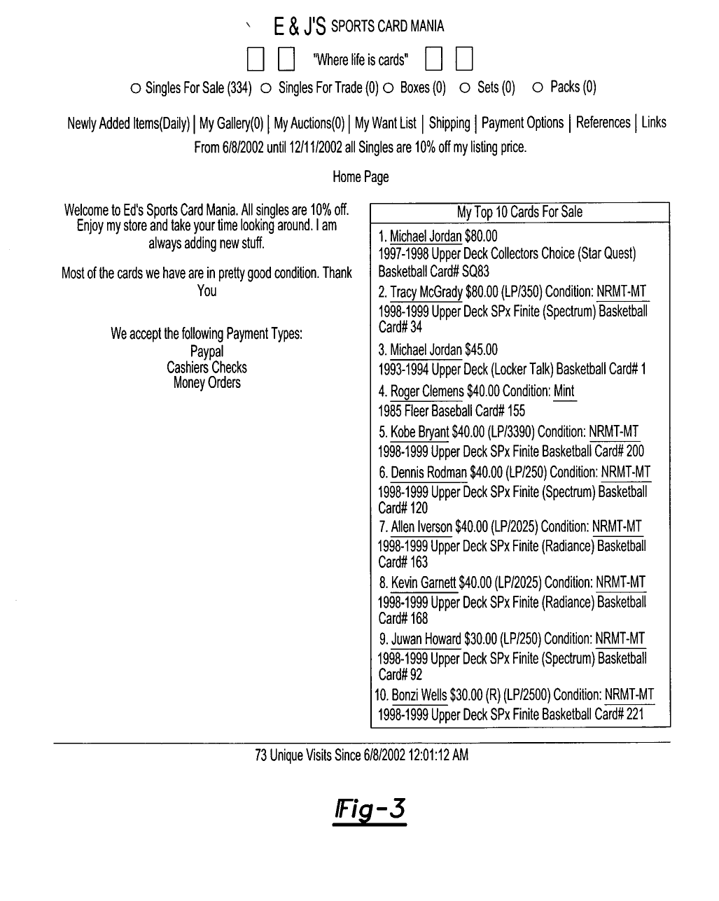

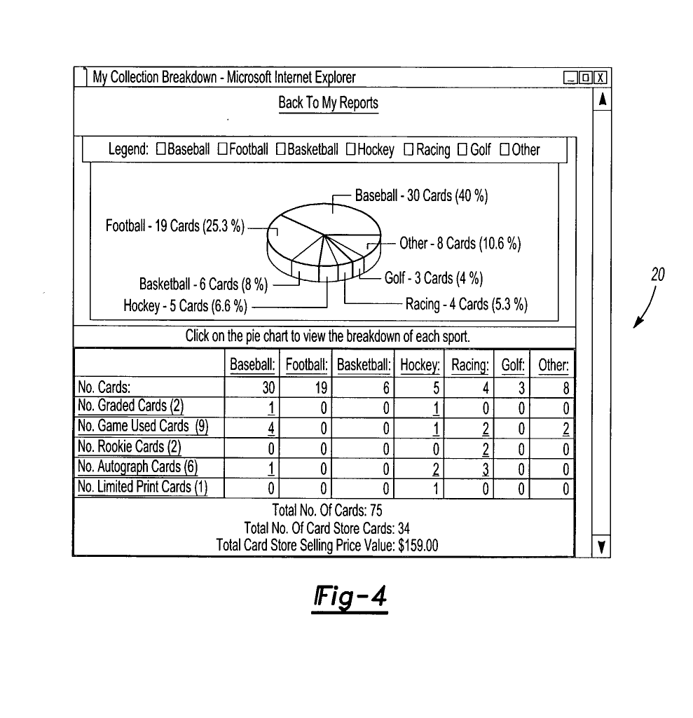

Referring to FIG. 2, each store 18 is configured by the user such that each store may be distinct from other stores within the system 10. A user is provides with options to modify the store name, store colors, shipping costs, payment options, enable or disable their hit counter, display contact information, auction listings, gallery listings, and select the time period in which their newly added items are displayed. It should be understood that other unique configuration features will also benefit from the present invention. Once a user subscribes to the system and creates a store 18 (FIG. 3), the user may begin to add inventory (FIG. 4).

Referring to FIG. 4, each collectable is added to an inventory list 20. The user can add the collectables individually, as boxes, sets, packs or any other predefined or user-defined grouping.

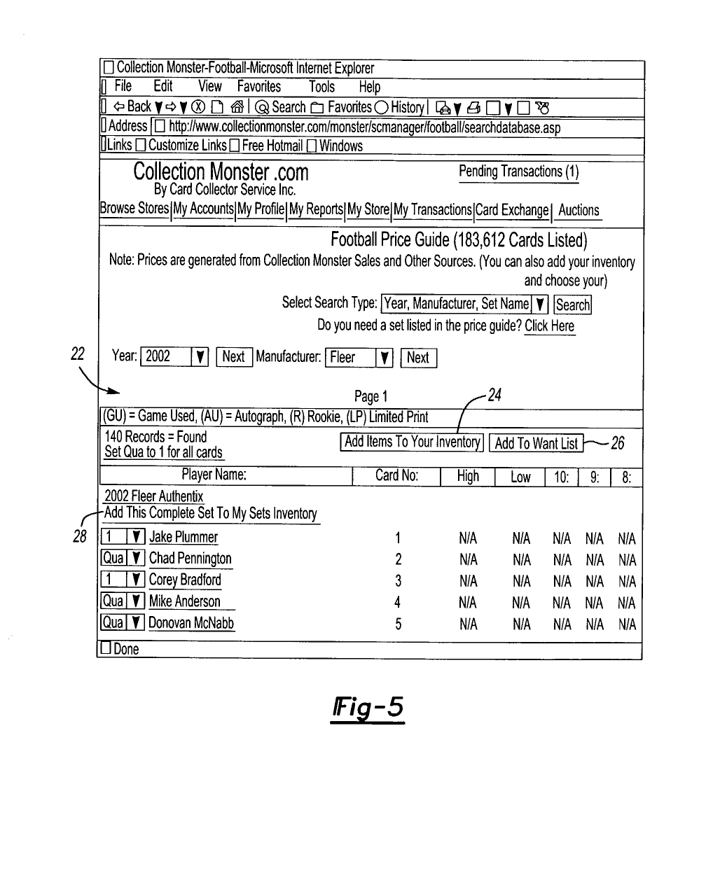

Referring to FIG. 5, the system 10 contains a complete reference digest 22 of all collectables. For example only, encyclopedic guides are published which simply recite all know collectable of a particular type such as sports cards. The system 10 provides such a reference digest which is accessible by each registered user. The reference digest 22 allows users to search and browse through a large database of collectable to find prices and information of known boxes, sets pack or other related collectable. The reference digest 22 also allows users to effortlessly add a collectable to their inventory (schematically illustrated at 24) and Want List (schematically illustrated at 26) as will be further described below.

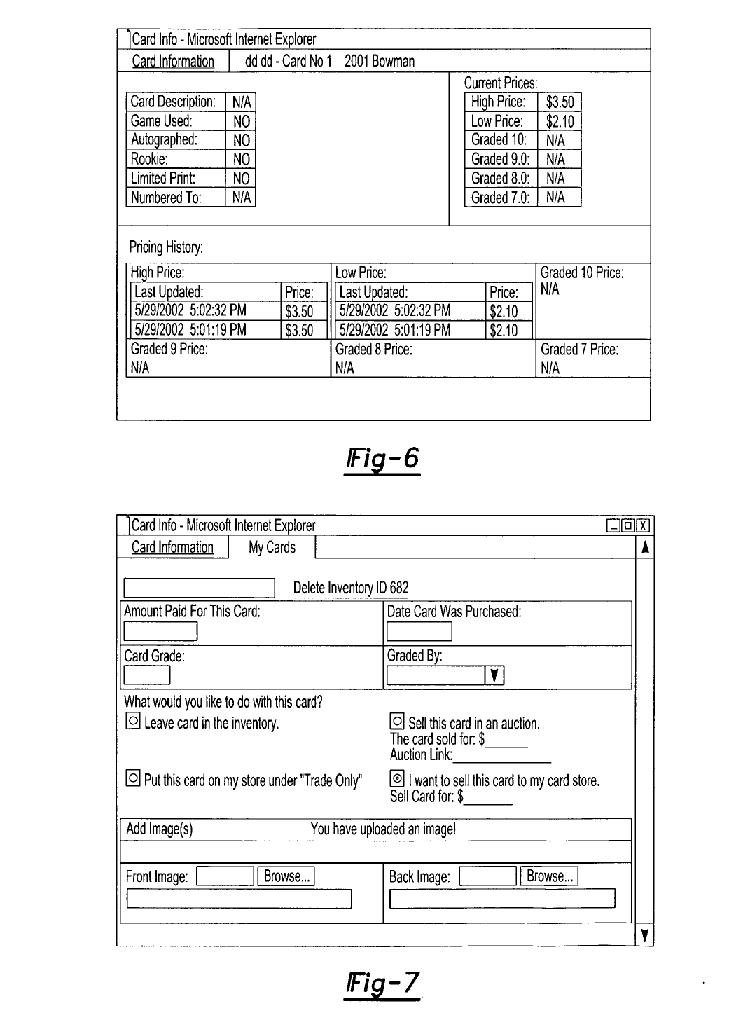

Initially, the reference digest 22 is a list of, for example only, of every football card (FIG. 5) ever produced. As transactions take place within the system the reference digest 22 is updated each execution. That is, when a particular collectible is sold, the price of the sale is tracked and stored within the reference digest 22. A value trade history or “stock market” like valuation is therefore generated which is updated as more sales are completed. Once a predetermined threshold is reached for a particular card, the reference digest 22 displays a suggested valued for the particular card (FIG. 6). For example only, card X of grade Y has been sold within the system 10 Z number of times for a value between A and B. Individual users are thereby provided with an estimated worth of the card.

Valuation within the reference digest 22 is also updated by users input. When a user ads are card to inventory, that particular card may have been valued by a third party. The system 10 preferably queries the user whether the card has been graded (FIG. 7). If so, the user selects the grade the card received, provides when the card was purchased and the price, and selects the third party that graded the card. This information therefore provides a separate Valuation within the reference digest 22 accessible to users 12. That is, even after a user may close a store the valuation information is maintained within the reference digest 22 for future use.

If the store owner is browsing their own store, the shopping portion of the site is disabled. This prevents the user from buying items from themselves to try and manipulate the pricing data that will generate the Collection Monster pricing.

As many trading cards are originally distributed in multiples, the user need only select which multiple (add this complete set to my sets inventor; FIG. 5 at 28) to add into the store inventory. The system 10 then adds each individual card from that box, set or pack to the user's store inventory. The user may then select whether each collectable may be individually sold or traded or whether the particular collectible will only be sold/traded as part of the larger set.

The inventory list provides user selectable transaction option for each collectable. The user 12 is preferably provided with options such as: mark the collectable For Sale for a particular price; mark the collectable For Trade; mark the collectable for auction on a third party auction site; or mark the collectable for display only. The inventory list also includes attachment of one or more images of the collectable to further facilitate trading. The images are displayed in the each users store and may be stored on a third party site such as Filingtank.com.

Mass update for the inventory is also provided by the system 10. Preferably, search categories such as: All; Selling On Store; Accepting Trade Offers; At Auction; and for display only are provided. Once a category of collectables are selected, user options are provided as follows: View Only, Sell On Store, Trade On Store, Add To Auctions, Put In Inventory Only, and Print Labels. It should be understood that multiple ways to lookup and modify the inventory will benefit from the present invention.

Various purchase and trading options for a user to obtain collectables are also provided. Again, unlike conventional auction sites which do not have such request options, a user of the present invention is provided with a collector specific interaction experience.

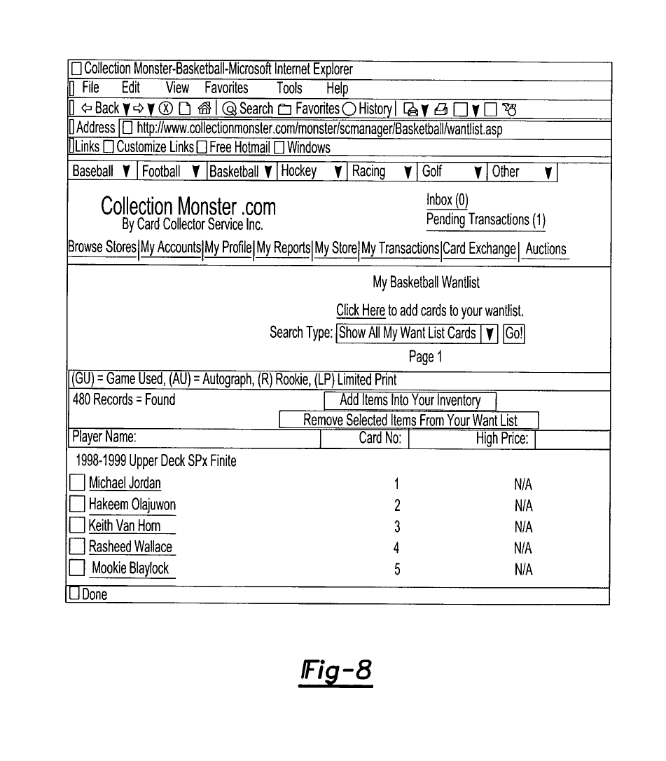

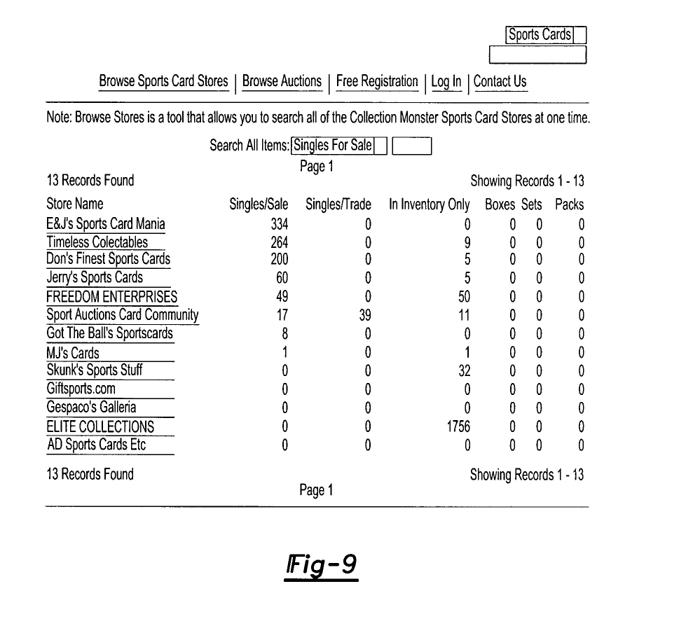

As the reference digest 22 contains all known collectables, a user generates a Want List (FIG. 8) by browsing the reference digest 22 and selecting the desired cards. A user Want List is then displayed on the users store such that it is available to others. Interaction with other collectors who may want to trade or sell the wanted collectable is thereby facilitated.

A user performs searches to obtain links that relate to the stores 18 (FIG. 9) that have the searched for collectable. The user can then compare prices of various stores. Preferably, a user searches from a buyers market which displays all collectables that the user has marked in their Want List and that are available For Sale or trade on other user's stores. A Seller's Market displays all of the items that the user is selling in their store and matches up what the user is selling with other user's Want List. The user can then communicate with the other users who have the collectable which is on another user's Want List. That is, communication is facilitated to suggest sales/trades by matching up Want Lists with sale/trade inventories for buyers and sale/trade inventories with user Want Lists for sellers/traders.

The system 10 includes a promotion option which are additional sale benefits. By selecting the promotion start and end dates, the promoted collectables are displayed in association with a promotional percentage decrease in price. A buyer having one card on a Want List may thereby be notified that the single collectable may be part of a larger box, set or pack which is being offered at a promotional price.

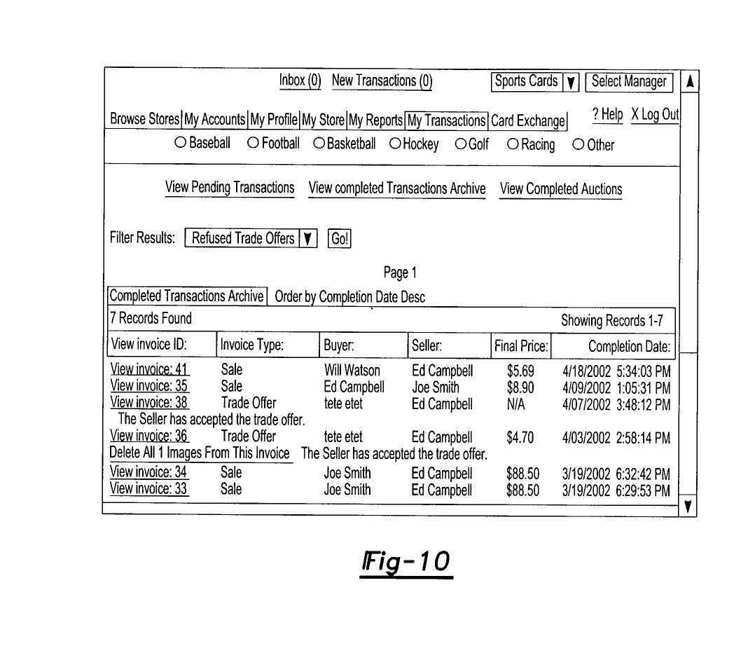

Referring to FIG. 10, the system 10 provides various reports specific to collectables. Transaction reports give the user a detailed viewing of all of their completed transactions and completed auctions. The user can use a date range to view what their profits were for a certain time period. Pie charts are generated to give the user a better view of their transactions. The pie charts are preferably dynamic and interactive. That is, by selecting a portion of the pie, more detailed information are provided with regard to the selected portion.

Pending transactions are transactions that have yet to be completed. If the user is the seller they have many options: If the buyer backs out of a deal, the seller can cancel the transaction and their items will be reposted on to their store. If the transaction is completed the seller can leave feedback on the buyer. The seller can print an invoice of the transaction. The buyer has many options also: The buyer can back out of a transaction, leave feedback on the seller, and print the invoice for the transaction. Transactions are broken into two separate types, Sold Items and Trade Offers.

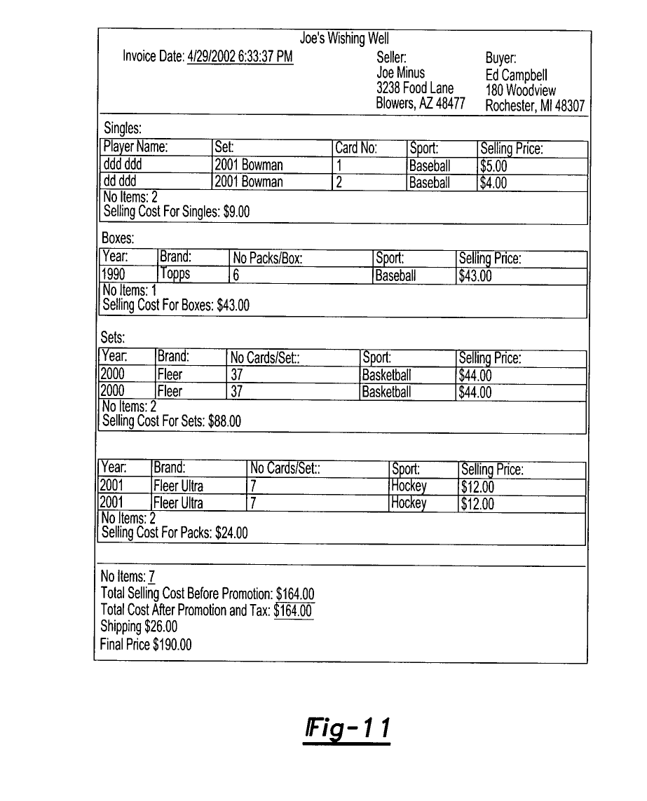

Once a pending transaction has been completed, the transaction is archived under this section. Both the buyer and seller of the transaction can view the transaction, print the invoice (FIG. 11), and leave feedback on each other. The data from the completed transactions is used to drive the book value prices within Collection Monster.

Users have the option to add a card to their inventory and check the card as Selling In An Auction. If the user does this, once the auction has been completed, the user is provided with the option to input the price the item sold for. The reference digest 22 is then further updated. Once the user adds this data, the card is removed from their inventory and placed under Completed Auctions Archive. Preferably, the card is automatically transferred from the sellers inventor to the buyers inventory. That is, once the transaction is completed the buyer does not have to reenter the purchased card into his inventory. The act of trading a collectable is therefore reflected in a manner to one person actually physically giving the card to another. Of course, shipping of the physical card is worked out between the buyer and seller in a conventional manner.

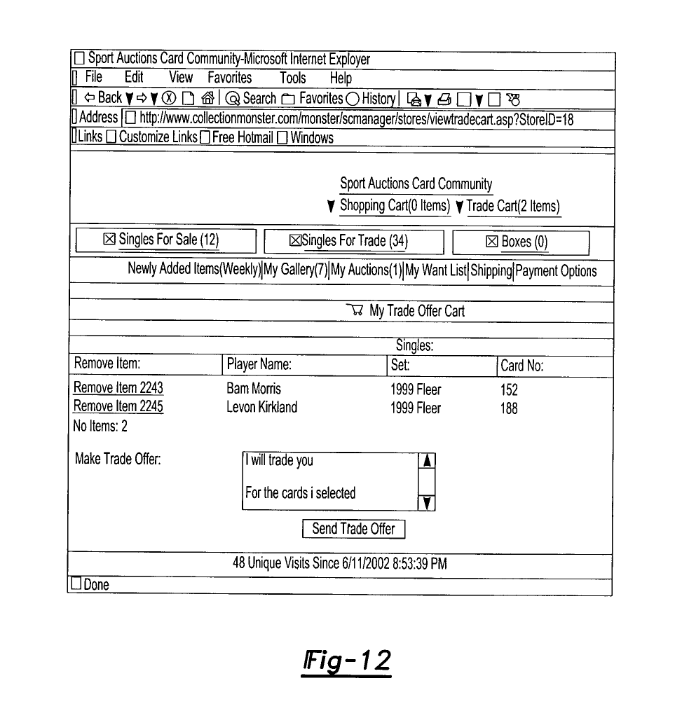

Referring to FIG. 12, an Internal Messaging system allows users to send other users Internet e-mail messages to suggest buying selling and trading proposals. Preferably, chat rooms allow users to chat with other users in the sport/collectable user they are in. Each sport/collectable has its own chat room. The user can also invite another user to the chat room from a pick-list displaying every user that is currently logged in.

The system 10 also allows a user to close their store for a period of time. By selecting the day they are leaving and the day they will be returning; the store will display a bold message on every page during this time period stating that the store owner will not be available to view any transaction during this time. Customers, however, can still use the shopping cart and start a transaction knowing that the store owner will not be available until the return date stated.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method for managing collectables between a plurality of users through a communication network comprising the steps of:
(a) associating each of a plurality of users with a store;
(b) maintaining an inventory for each of the plurality of stores, each inventory comprising a plurality of collectables; and
(c) communicating between each of the plurality of stores through a communication network such that a collectable in a first inventory is transferable to a second inventory.

2. A method as recited in claim 1, wherein said step (9) further comprises displaying a user defined store design for each of the plurality of users.

3. A method as recited in claim 1, further comprising the step of:
maintaining a Want List within each inventory for each of the plurality of stores, each Want List comprising a plurality of collectables.

4. A method as recited in claim 1, further comprising the step of:
maintaining a display list within each inventory for each of the plurality of stores, each display list comprising a plurality of collectables which are non-transferable.

5. A method as recited in claim 1, further comprising the step of:
maintaining a For Sale list within each inventory for each of the plurality of stores, each For Sale list comprising a plurality of collectables offered For Sale.

6. A method as recited in claim 1, further comprising the step of:
maintaining a For Trade list within each inventory for each of the plurality of stores, each For Trade list comprising a plurality of collectables offered For Trade.

7. A method as recited in claim 1, further comprising the steps of:
defining a plurality of predefined categories;
separating each collectable from each inventory into one of the plurality of predefined categories; and
communicating between each of the plurality of stores in said step (c) with respect to the plurality of predefined categories.

8. A method as recited in claim 1, further comprising the steps of:
maintaining a reference digest accessible by each of the users, the reference digest comprising a list of known collectables; and
generating each inventory by selecting a collectable from the reference digest.

9. A method as recited in claim 1, further comprising the steps of:
(d) maintaining a reference digest accessible by each of the users, the reference digest comprising a list of known collectables comprising a first collectable and a first valuation for the first collectable;
(e) tracking a sale price for each collectable similar to the first collectable transferred between the first inventory and the second inventory; and
(f) updating the first valuation for the first collectable in response to the sale price from said step (e).

10. A method as recited in claim 9, further comprising the steps of:
(g) classifying the first collectable within the reference digest with a grade; and
(h) relating the first valuation to the grade.

11. A method as recited in claim 1, further comprising the steps of:
(d) maintaining a reference digest accessible by each of the users, the reference digest comprising a list of known collectables comprising a first collectable and a first valuation for the first collectable;
(e) requesting a purchase price and a grade for each collectable similar to the first collectable from each user inputting each collectable similar to the first collectable into one of the plurality of inventories; and
(f) updating the first valuation for the first collectable in response to said step (e).

12. A method as recited in claim 1, further comprising the steps of:
(d) maintaining a reference digest accessible by each of the users, the reference digest comprising a list of known collectables comprising a first grade and a first valuation for a first collectable of the first grade and a second grade and a second valuation for the first collectable of the second grade;
(e) requesting a purchase price and a grade for each collectable similar to the first collectable from each user inputting each collectable similar to the first collectable into one of the plurality of inventories;
(f) updating the first valuation for the first collectable in response to said step (e) for each collectable similar to the first collectable and of the first grade; and
(g) updating the second valuation for the first collectable in response to said step
(e) for each collectable similar to the first collectable and of the second grade.

13. A method for managing collectables between a plurality of users through a communication network comprising the steps of:
(a) associating each of a plurality of users with a store;
(b) maintaining an inventory for each of the plurality of stores, each inventory comprising a plurality of collectables;
(c) communicating between each of the plurality of stores through a communication network such that a collectable in a first inventory is transferable to a second inventory;
(d) maintaining a reference digest accessible by each of the users, the reference digest comprising a list of known collectables comprising a first collectable and a first valuation for the first collectable;
(e) tracking a sale price for each collectable similar to the first collectable transferred between the first inventory and the second inventory; and
(f) updating the first valuation for the first collectable in response to the sale price from said step (e).

14. A method as recited in claim 13, further comprising the step of:
maintaining a Want List within each inventory for each of the plurality of stores, each Want List comprising a plurality of collectables.

15. A method as recited in claim 13, further comprising the step of:
maintaining a display list within each inventory for each of the plurality of stores, each display list comprising a plurality of collectables which are non-transferable.

16. A method as recited in claim 13, further comprising the step of:
maintaining a For Sale list within each inventory for each of the plurality of stores, each For Sale list comprising a plurality of collectables offered For Sale.

17. A method as recited in claim 13, further comprising the step of:
maintaining a For Trade list within each inventory for each of the plurality of stores, each For Trade list comprising a plurality of collectables offered For Trade.

18. A method as recited in claim 13, further comprising the steps of:
maintaining a Want List within each inventory for each of the plurality of stores, each Want List comprising a plurality of collectables;
maintaining a For Sale list within each inventory for each of the plurality of stores, each For Sale list comprising a plurality of collectables offered For Sale;
maintaining a For Trade list within each inventory for each of the plurality of stores, each For Trade list comprising a plurality of collectables offered For Trade; and
matching each Want List to each For Sale list and For Trade list.

19. A method as recited in claim 13, wherein said matching step including providing communication between a first and second store having matching collectables.
